(19) United States
(12) Patent Application Publication
(10) Pub. No.: US 2026/0037600 A1
(43) Pub. Date: Feb. 5, 2026

(54) MECHANISMS FOR GENERATING AUGMENTED SENSOR DATA

(71) Applicant: Five AI Limited, Cambridge (GB)

(72) Inventors: Alexandru Buburuzan, Cambridge (GB); Romain Mueller, Cambridge (GB)

(73) Assignee: Five AI Limited, Cambridge (GB)

(21) Appl. No.: 19/287,105

(22) Filed: Jul. 31, 2025

(30) Foreign Application Priority Data
Jul. 31, 2024 (GB) 2411261.7

(51) Int. Cl. G06F 18/214; G06N 3/0475; G06N 3/084

(52) U.S. Cl. CPC G06F 18/2148; G06N 3/0475; G06N 3/084

(57) ABSTRACT

The present disclosure relates to techniques for training a generative model to insert an object in spatial sensor data. A first training sample of spatial sensor data of a first sensor modality, and a second training sample of spatial sensor data of a second sensor modality are received, the first training sample and the second training sample capture a common object. A first portion of sensor data corresponding to the object is removed from the first training sample, resulting a cropped training sample. A second portion of spatial sensor data corresponding to the common object is extracted from the second training sample. The generative model is trained to reconstruct the first training sample from the cropped training sample by: providing to the generative model: the cropped training sample as a target input, and the second portion of spatial sensor data as a reference input, resulting in a generated output sample of spatial sensor data, and tuning parameters of the generative model to reduce a reconstruction error between the first training sample and the generated output sample. This results in a trained generative model configured to insert at inference, in a first set of spatial sensor data of the first modality received as a target input, an object indicated in a second set of spatial sensor data of the second modality received as a reference input.

### CROSS REFERENCE TO RELATED APPLICATION

This application claims priority under 35 U.S.C. § 119 to Great Britain Patent Application No. 2411261.7, filed Jul. 31, 2024, the entire content of which is incorporated herein by reference.

### FIELD

The present disclosure relates to mechanisms for generating augmented sensor data.

### BACKGROUND

Computer vision techniques used to analyze images have advanced significantly in recent years, enabling (among other things) objects and their characteristics to be identified in images with a high level of accuracy. Significant advances have also been achieved in comparable techniques (such as object detection) in other sensor modalities, such as lidar or radar point clouds. Such processing can support a wide range of applications, one example being robotics. There have been major and rapid developments in the field of autonomous vehicles and mobile robots. An autonomous vehicle (AV) is a vehicle which is equipped with sensors and control systems which enable it to operate without a human controlling its behaviour. An autonomous vehicle is equipped with sensors which enable it to perceive its physical environment, such sensors include for example cameras, RADAR and LIDAR. Autonomous vehicles are equipped with suitably programmed computers which are capable of processing data received from the sensors and making safe and predictable decisions based on the context which has been perceived by the sensors. The term autonomous vehicles as used herein covers semi-autonomous vehicles (e.g. level 2, level 3, level 4 autonomous) as well as fully-autonomous (level 5). Other mobile robots are being developed, for example for carrying freight supplies in internal and external industrial zones. Such mobile robots would have no people on board and belong to a class of mobile robot termed UAV (unmanned autonomous vehicle). Autonomous air mobile robots (drones) are also being developed.

Advances in techniques for processing images, lidar, radar etc. have been largely driven by large-scale data collection and training using machine learning (ML) models and techniques. Moreover, safety-critical applications (such as autonomous vehicles) require large amounts of data for testing purposes, to ensure they are capable of operating at a high level of safety. A particular challenge in autonomous driving is that rigorous testing needs to be performed before an AV can be deployed in the real-world, meaning that an increasing emphasis is being placed on simulation-based testing.

Accordingly, the use of synthetic sensor data is becoming more prevalent. For example, computer vision models (such as convolutional neural networks (CNNs)) have been trained on large training sets containing a mixture of real and synthetic images. As another example, sensor-realistic simulations have been used in performance testing of perception components used advanced robotic systems, where such components may be tested in isolation or in combination with other components of a robotic stack.

Conventionally, synthetic sensor data has been generated using ‘classical’ physics-based sensor models. For example, images may be synthesized from a 3D model using graphics rendering techniques, such as ray tracing. Similarly, physics-based models may be used to generate synthetic lidar or radar points clouds.

### SUMMARY

A core challenge addressed herein is that of generating realistic synthetic data in a controlled manner. The need for realistic sensor data arises in many applications. For example, certain ML models, such as CNNs used in computer vision, are highly sensitive to even small discrepancies between real and synthetic images. Therefore, when training, testing or validating such models using synthetic sensor data, the sensor data needs to be synthesized with a high degree of realism. Moreover, certain sensor modalities (such as radar) are inherently difficult to simulate realistically using classical physics-based models. The ability to control the generation process is also important. For example, in an AV context, small deviations in a perceived environment can result in materially different driving behavior. When utilizing synthetic sensor data in such contexts (for whatever purpose), it is therefore important that the generation process can be suitably controlled.

The techniques described herein implement a form of data augmentation, enabling a set of sensor data to be augmented with an object (not present in the original sensor data) in a realistic and controlled manner.

A first aspect of the present disclosure provides a computer-implemented method of training a generative model to insert an object in spatial sensor data, the method comprising: receiving a first training sample of spatial sensor data of a first sensor modality, and a second training sample of spatial sensor data of a second sensor modality, the first training sample and the second training sample capturing a common object; removing from the first training sample a first portion of sensor data corresponding to the object, resulting a cropped training sample; extracting from the second training sample a second portion of spatial sensor data corresponding to the common object; and training the generative model to reconstruct the first training sample from the cropped training sample by: providing to the generative model: the cropped training sample as a target input, and the second portion of spatial sensor data as a reference input, resulting in a generated output sample of spatial sensor data, and tuning parameters of the generative model to reduce a reconstruction error between the first training sample and the generated output sample, resulting in a trained generative model configured to insert at inference, in a first set of spatial sensor data of the first modality received as a target input, an object indicated in a second set of spatial sensor data of the second modality received as a reference input.

In this manner, the generative model is trained using a reference input that captures the same object as the first training sample to be reconstructed but in a different sensor modality. This improves the performance of the trained generative model, as it is able to accurately insert a desired object represented in one modality (e.g. image) into a sample of another modality (e.g. point cloud). The accuracy of object insertion is improved, as the generative model has been exposed to multimodal representations of the same object in training.

In embodiments, the first training sample is a point cloud and the second training sample is an image.

The ability to manipulate point clouds based on images has the benefit of providing an intuitive visual mechanism for point cloud manipulation.

The point cloud may be a lidar point cloud or other 3D point cloud.

The method may comprise removing from the second training sample the second portion of sensor data, resulting a second cropped training sample; wherein the generative model may additionally be trained to reconstruct the second training sample from the second cropped training sample by additionally providing to the generative model the second cropped training sample as a second target input, resulting in a second generated output sample of spatial sensor data, the parameters of the generative model to additionally reduce a reconstruction error between the second training sample and the second generated output sample.

A conditioning input encoding a 3D geometric property of the common object may be provided to the generative model for the cropped training sample.

A second conditioning input encoding the 3D geometric property may additionally be provided for the second cropped training sample, the conditioning input and second conditioning input representing the 3D geometric property in respective coordinate systems of the first training sample and the second training sample.

The conditioning input and second conditioning input may be determined via projection of a 3D object model into the respective coordinate systems.

The 3D object model may be detected automatically based on the spatial sensor data of a first sensor modality of the first training sample.

The first sensor modality may be a lidar modality and the second sensor modality may be a camera modality.

The 3D geometric property of the object may indicate a 3D location, 3D pose and/or 3D extent of the object.

The 3D geometric property of the object may be a 3D bounding box or other 3D object model indicating a 3D location, pose and extent of the object.

The conditioning input may be determined based on a projection of a 3D bounding box or other 3D object model into a view of the training sample.

A second conditioning input denoting a label embedding associated with the common object may also be provided to the generative model.

The conditioning input may be used to generate the cropped training sample.

The common object may be detected and annotated automatically based on the spatial sensor data of the training sample or other spatial sensor data associated with the training sample.

The reconstruction error may be measured between latent space representations of the training sample and the generated output sample.

The generative model may operate on vector representations of the target input and the reference input.

The generative model may be a diffusion model and employ a diffusion process to generate the output sample, the diffusion process may comprise: generating a series of increasingly noisy outputs of the target input and the reference input in a Markov forward process for a set of timesteps T; denoising the noisy outputs during a reverse process at each time step of the set of timesteps T, starting from T, to generate a denoised output; generating a noisy training sample by adding an expected noise to the training sample at every timestep; and minimizing a loss function between the noisy training sample and the denoised output at every timestep of the reverse process.

The generative model may receive a CLIP encoding of the reference input at every timestep of the diffusion process.

The conditioning input may be received by the generative model at every timestep.

The point cloud may be encoded in the first training sample as a quantized projection in a view plane.

A second aspect of the present disclosure provides a computer-implemented method of using a trained a generative model to insert a desired object in spatial sensor data at inference, the method comprising: receiving an input sample of first spatial sensor data of a first sensor modality; receiving a reference input of second spatial sensor data of a second sensor modality, the second spatial sensor data capturing a desired object; providing to the trained generative model the input sample of first spatial sensor data and the reference input, resulting in an augmented output sample of the first spatial sensor data comprising the input sample of the first spatial sensor data augmented with the second spatial sensor data reflecting the desired object.

In embodiments, the method may comprise receiving an input sample of second spatial sensor data and providing to the trained generative model the input sample of second spatial sensor data, resulting in an augmented output sample of the second spatial sensor data comprising the input sample of the second spatial sensor data augmented with the second spatial sensor data reflecting the indication of the desired object.

A conditioning input encoding a 3D geometric property of the desired object may be provided to the generative model.

Further optional features of the second aspect are as defined above in relation to the first aspect and may be combined in any combination.

According to a third aspect, there is provided a computer system comprising computer memory and one or more processors configured to perform the steps of the method of the first and/or second aspects.

Further optional features of the third aspect are as defined above in relation to the first and second aspects and may be combined in any combination.

According to a fourth aspect, there is provided a computer program comprising executable instructions which, when executed by one or more processors, causes the processors to implement the methods of the first and/or second aspects.

Further optional features of the fourth aspect are as defined above in relation to the first, second and third aspects and may be combined in any combination.

### BRIEF DESCRIPTION OF THE DRAWINGS

To assist understanding of the present disclosure and to show how embodiments may be put into effect, reference is made by way of example to the accompanying drawings in which:

FIG. 1A shows a highly schematic bock diagram of an AV runtime stack.

FIG. 1B shows a highly schematic overview of a testing paradigm for autonomous vehicles.

FIG. 2 shows a block diagram of an example self-supervised training method for a synthesized data generation model for one sensor modality.

FIG. 3 shows a block diagram of an example trained synthesized data generation model at inference time.

FIG. 4 is an example of the inputs and outputs of a synthesized data generation model for one sensor modality.

FIG. 5 shows a block diagram of an example self-supervised training method for a multimodal synthesized data generation model.

FIG. 6 shows a block diagram of an example trained multimodal synthesized data generation model at inference time.

FIG. 7 shows a block diagram of an example training method for generating LIDAR and image data using a multimodal diffusion model.

FIG. 8 shows a schematic function block diagram of a graphical tool for defining a 3D conditioning input at inference.

### DETAILED DESCRIPTION

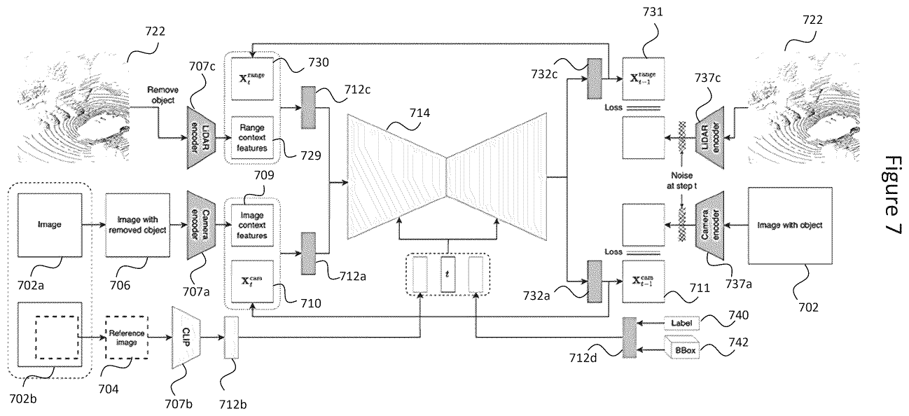

In one embodiment described below, a multi-modal spatial sensor data augmentation ML architecture for a generative model is described, which enables multiple sets of sensor data of different sensor modalities to be augmented with an object, subject to a 3D geometric object constraint received at inference as a conditioning input, e.g. represented in the form of a conditioning token. For example, in one implementation, a target image and a target point cloud (e.g. lidar or radar) to be augmented are received as inputs, along with a reference image depicting a reference object to be inserted (into both the target image and the target point cloud) and a conditioning input defining a 3D bounding box (that is, 3D location, 3D pose and 3D extent) of the reference object to be inserted. The aforementioned architecture is depicted in FIG. 7, and described in detail below. Whilst 3D bounding boxes are considered, other forms of 3D object model could be used (such as a 3D object template, e.g. vehicle template, providing basic shape information).

Note the term ‘spatial sensor data’ as used herein refers to any form of sensor data in which the structure of an object(s) and/or environment is captured. The term encompasses sensor modalities such as image, lidar and radar. The term encompasses both images and point clouds. The sensors may be an image sensor and/or a LIDAR sensor.

The described architecture builds on that of Yang et al. “Paint by example: Exemplar-based image editing with diffusion models.” Proceedings of the IEEE/CVF Conference on Computer Vision and Pattern Recognition 2023 which discloses an image-conditioned diffusion model trained in a self-supervised manner to alter image content based on an exemplar image. The image editing method described therein generates synthesized images by receiving a source image and a reference image, containing an object, as input. The object in the reference image is ‘inserted’ into the source image such that it appears as though the object was originally in the source image. This is achieved by automatically merging the object in the reference image into a source image using an edit region represented as a binary mask. The area in which the binary mask is set to zero is the same as possible to the source image, while the region in which the mask is set to one depicts the object as similar to the reference image as possible.

The architecture described herein improves on the paint-by-example architecture of Yang in various respects. The addition of a conditioning input enabling the 3D geometry of the object to be controlled at inference enabling greater control and improved realism. Moreover, the architecture is extended to non-image sensor modalities, such as lidar, radar etc., enabling a greater range of applications. Together, these improvements open up new applications such as training, testing and validation of perception components in safety-critical contexts such as autonomous driving.

It is noted that the aforementioned elements architecture of FIG. 7 can be implemented independently.

For example, the ability to specify geometric constraints (such as a 3D bounding box or other 3D object model) on the reference object at inference can be implemented in simpler single-modality architectures. For example, in a single-modality image generation architecture, a 3D bounding box can be used to insert a reference object into a 2D image with a realistic and controlled 3D perspective.

Likewise, a multi-modal architecture can be implemented without the use of such a conditioning input. In the broadest sense, “multi-modal” generation refers to the ability to use a reference input of a first sensor modality (e.g. image) to insert a reference object in a target input of a second sensor modality (e.g. lidar or radar). The ability to modify point clouds using reference images is useful in many contexts.

Embodiments of a method for multimodal object generation are described below. The described embodiments use a form of synthetic data generation to create test data for autonomous vehicle stacks, enabling efficient generation of useful test scenarios in multiple sensor modalities.

In common with Yang, self-supervised training mechanisms are used. At a high level, a generative model is trained based on a reconstruction task. An object is isolated in a training sample and cropped out from it, and the generative model is trained to reconstruct the original sample from the cropped sample (using the original training sample as ground truth input to a self-supervised training loss function). However, there are key differences in the training architecture with respect to Yang, which are highlighted below.

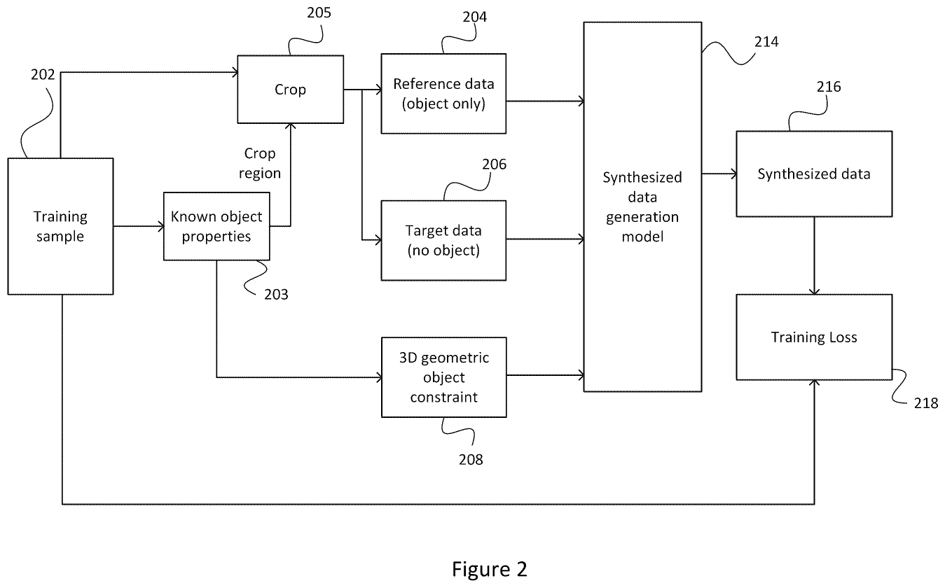

FIG. 2 shows a block diagram of an example self-supervised training method for synthesized data generation. The training setup of FIG. 2 enables a generative model to be trained, in a self-supervised manner, to augment a target sample with an object exhibiting a 3D geometric constraint specified in a conditioning input at inference.

FIG. 2 shows a generative model 214 to be trained. The training is supported by a cropping component 205.

A training sample 202 is depicted, which is a sample of spatial sensor data. For example, the training sample 202 may be an image or a point cloud (e.g. radar or lidar point cloud). To construct a self-supervised training task, a reference sample 204 and a target sample 206 are derived from the training sample 202. This involves isolating and removing an object captured in the training sample 202 (referred to as the reference object). The reference sample 204 is a subset of the spatial sensor data corresponding to the reference object (the sensor data that has been cropped-out from the training sample 202), whereas the target sample 206 is a subset of the spatial sensor data from which sensor data corresponding to the reference object has been removed.

The training sample 202 is associated within one or more known object properties 203 of the reference object. As a minimum, these include a 3D geometric property 208 of the object, such as a 3D location, 3D pose or 3D extent. For example, the known object properties 203 may comprise a 3D bounding box/model characterizing all three. The object properties 203 may be determined automatically (e.g. using a machine learning object detector) or via manual annotation.

The known object properties 203 are used to identify a crop region to crop the reference object output of the training sample 202. For an image, the crop region may be a 2D bounding box or other 2D image region (e.g. determined via segmentation of the image). This can be determined from a 3D bound box via projection of the 3D bounding box into the image plane. Alternatively, it may be separately determined using a 2D object detector, though manual annotation etc. For a 3D point cloud, the 3D bounding box can be used to crop the object out of the 3D point cloud directly.

The reference sample 204 and target sample 206 are provided as target and reference inputs to the generative model 214 respectively.

For example, the training sample 202 may be an example image of a road containing a vehicle. The vehicle in the image may be annotated with a bounding box. The reference data 204 may be the contents of the bounding box, including the vehicle, extracted from the training sample 202.

The generative model 214 is architected to generate an output sample 214 comparable in form to the original training sample 202. With a target sample in the form of an image, the output sample is also in the form of an image. With a target sample in the form of a point cloud, the output sample is also in the form of a point cloud. A training loss 218 is used which measures a reconstruction error between the original training sample 202 and the output sample 216. Although only a single training example is depicted, in practice a large training set of such examples will be used. By tuning parameters of the generative model 214 to minimize this reconstruction error across the training set, the generative model 214 learns to insert ‘synthetic’ sensor data into the target sample 206 in a way that substantially reproduces the original training sample 202. In training, the reference sample 204 and target sample 206 are derived from the same training sample 202. However, once trained, the trained generative model 214 is able to generalize knowledge learned in training, enabling the target and reference inputs to be freely chosen. To enable such generalized learning, an abstracted representation of the reference sample 204 can be used to prevent ‘overfitting’ whereby the generative model merely learns to ‘copy-and-paste’ from the reference sample 204 into the target sample 206.

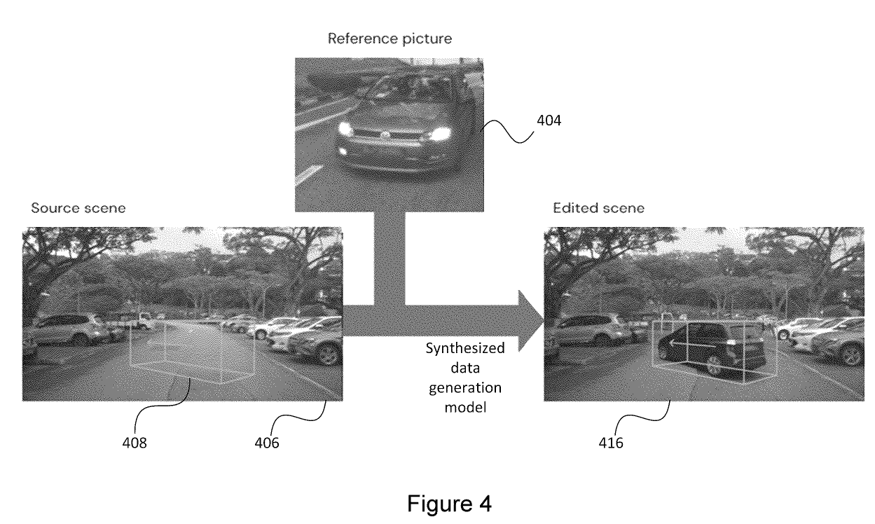

In addition, the 3D geometric object property 208 is provided as a geometric conditioning input. During training, the generative model 214 is able to use the known 3D geometric property 208 to assist in reconstructing the object. However, once trained, the geometric conditioning input can be used to specify the 3D geometry of a chosen reference object. Taking the example of a driving scene, a reference image or point cloud of a vehicle can be provided, to cause the model to insert a vehicle into the scene in a realistic manner. The additional conditioning input provides a much greater degree of control, as it enables 3D properties of the object (such as its 3D location, 3D pose and 3D orientation) to be specified. This is illustrated by example in FIG. 4, described below.

In images, the geometric conditioning input may be obtained by projecting a 3D bounding box onto the image using a transformation matrix. For an image captured from a real camera, an intrinsics matrix can be used to represent internal parameter(s) of the camera (such as focal length, aperture size etc.). The intrinsics matrix encodes the geometric relationship between 3D camera coordinates (3D points in the 3D coordinate system of the camera) to 2D pixel coordinates in the image plane. Therefore, a 3D bounding box/model represented in 3D camera coordinates (with ‘real-world’ coordinates/dimensions) can be projected into the image plane using the camera intrinsics matrix. A 3D bounding box has eight corners which can be represented using eight 3D corner points. In one implementation, a 3D box is projected into the image plane efficiently by projecting only the eight corner points into the image plane.

The following examples consider a normalized 2D coordinate system (x-y) describing the image plane, with x and y running from 0 to 1 across the extent of an image (the corner points of the image thus being (0,0), (0,1), (1,0), (1,1)). This is merely one possible implementation choice, and any x-y coordinate system (such as pixel coordinates) may be used. Each of the 8 points of the bounding box has 3 coordinates: x (from 0 to 1, 1 representing the image width), y (from 0 to 1, 1 representing the image height) and depth d (the distance from the camera, at the origin of the 3D camera coordinate system, to the point). Note that, although the 3D box is projected into the image plane, the addition of the depth dimension means no loss of 3D information. The orientation of the bounding box is reflected in the order of the projected 3D box corner points in the image plane.

For 3D point clouds, such as lidar point clouds, a similar approach may be used to represent the 3D point cloud and 3D bounding box in a chosen range view. A range view is an image-like representation of the point cloud, obtained by projecting the 3D point cloud and 3D bounding box into a chosen view plane. The projection may be quantized to provide a pixel representation of the 3D point cloud, e.g. with an occupancy channel denoting presence/absence of points and a depth channel denoting a depth of each occupied pixel (retaining 3D information of the point cloud). As the point cloud is 3D, the range plane can be freely chosen (e.g. to provide a camera-like view from a location of a lidar sensor, top-down ‘birds-eye-view’ etc.). In order to obtain the 3D bounding box for projection, the location of the object in the image is known as well as its size and orientation. This may be derived from the camera pose using odometry for example. For the range view (an image-like representation of a lidar scan), a different projection matrix may be used, but the format of the projected points is the same.

In the above examples, for both images and point clouds, a 3D bounding box is projected into a view of the training sample 202 (the image plane in the case of an image, and a freely chosen view plane in the case of a 3D point cloud). Transforming the 3D point cloud to image-like view enables the 3D point cloud to be represented (e.g., tokenized) and processed in the same way as images, using the same model (e.g. neural network) architectures. Alternative architectures may be used to process images directly (such as PointNet architectures). In this case, the 3D conditioning input 208 may be derived directly from the 3D bounding box, rather than via projection.

Whilst the above examples consider a full 3D bounding box, other implementations could use a simpler form of 3D object property or properties (such as a 3D object location and 3D object pose).

For a training sample 202 in the form of a 3D point cloud, the 3D geometric object property 208 of an object captured in the point cloud can be determined in various ways. For example, a 3D bounding box object detector (such as a 3D location estimation component, 3D pose estimation component, 3D bounding box detector, 3D segmentation component etc.) can be applied to the 3D point cloud to detect the 3D geometric object property 208. Alternatively, the 3D geometric object property 208 may be determined via a manual annotation of the 3D point cloud. Various tools to support 3D annotation of 3D point clouds are available.

For a training sample 202 in the form of a 3D point cloud, the 3D geometric object property 208 can similarly be determined in various way. For example, the image could be manually annotated with a projected 3D bounding box (e.g. by a human annotator placing a 3D bounding box in 3D camera coordinate systems, and adjusting the 3D box to visually align the projection of the 3D box with the object as it appears in the image). As another example, a machine learning detector may be applied to the image to detect the 3D bounding box projection. Various tools (such as mono depth detectors) can be used to infer 3D information from a 2D image. As an example, a 3D image (such as an RDBG image) could be used, with the 3D box inferred from a depth channel (D) of the 3D image. The depth channel could be determined using stereo imaging techniques rom on depth detection.

For an image captured simultaneously with a 3D point cloud (e.g. lidar, radar etc.), a 3D bounding box (or other 3D object property or properties) can be determined from the 3D point cloud in the manner described above, and projected into the image. This assumes that a geometric relationship between the camera system and the point cloud detector (e.g. lidar sensor, radar sensor etc.) is known or, in other words, the camera system is registered with the point cloud detector. For example, the 3D point cloud may be represented in 3D world coordinates, with a camera extrinsic matrix capturing a 3D location and 3D pose of the camera in world coordinates for a given image.

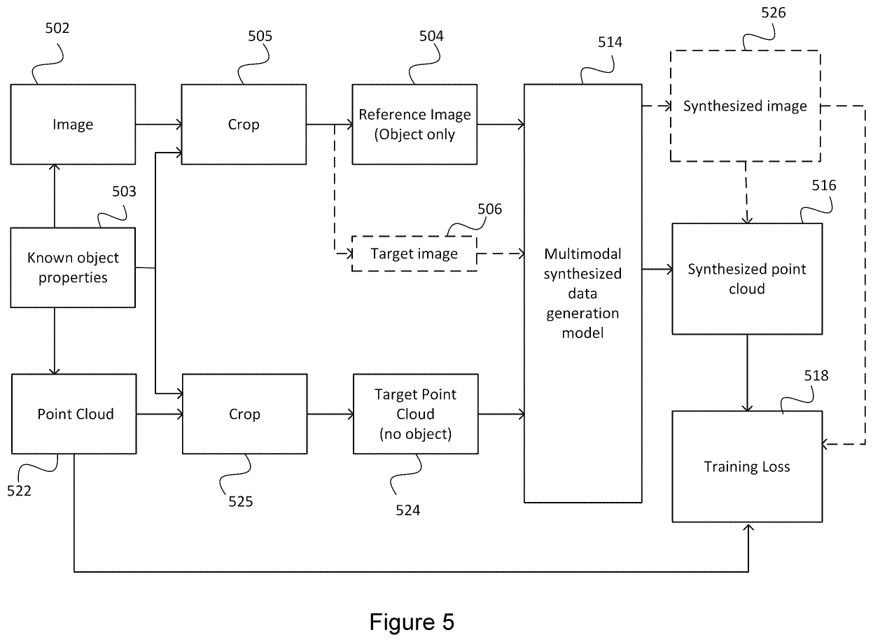

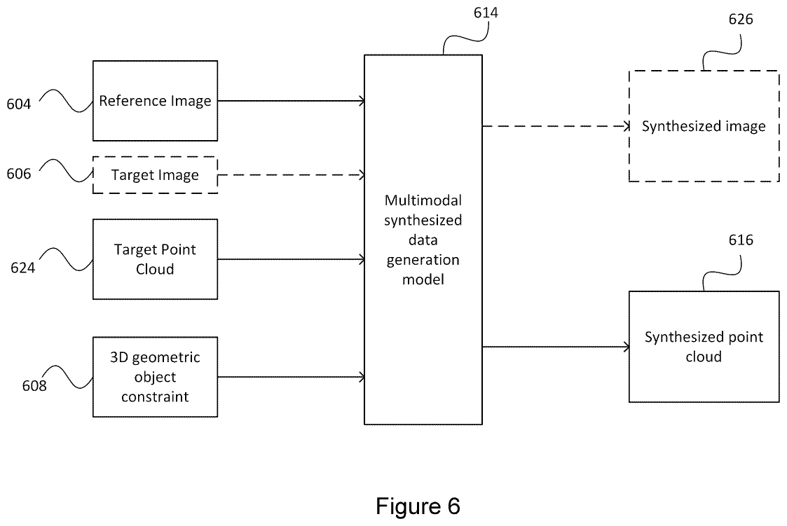

In a ‘single modality’ image-based implementation, a 3D point cloud captured simultaneously with a 2D image may be used only to derive the 3D object property 208 used in training. In a possible ‘multi-modality’ implementation, both the image and the point cloud may be used as inputs to the synthesis model (see FIGS. 5-6 and the accompanying description below).

The 3D geometric object constraint 208 may additionally comprise a label associated with the object in the training sample 202. The label may be a textual description of the object. The geometric conditioning input may be embedded and then concatenated with a label embedding (e.g. a feature vector for the textual description “car”).

The vectors representing the reference data 204 and target data 206, and the 3D geometric object constraint 208 are all input into the synthesized data generation model 214. All of the input data may be parsed through modality specific adaptors before being received by the synthesized data generation model 214. The modality specific adaptors may have been trained using data of the same modality as the inputs received by the adaptor, for example an image specific adaptor has been trained using image data. The synthesized data generation model 214 may be a diffusion model.

The reference data 204 and target data 206 may be encoded such that the synthesized data generation model 214 operates on a vector representation of the target data 206 in latent space. In such cases, the training loss 218 is calculated between a latent space representation of the synthesized data 216 and a latent space representation of the training sample 220. During training, the loss function 218 encourages the model 214 to gradually reduce the difference between the synthesized data 216 and the training sample 202. The training loss 218 uses an objective function to minimize the difference between the synthesized data 216 and the training sample 202.

Certain embodiments use a diffusion model, in which training is performed in a sequence of time steps, with incrementally reducing noise applied to the training sample 202 during training. This is described in further detail below.

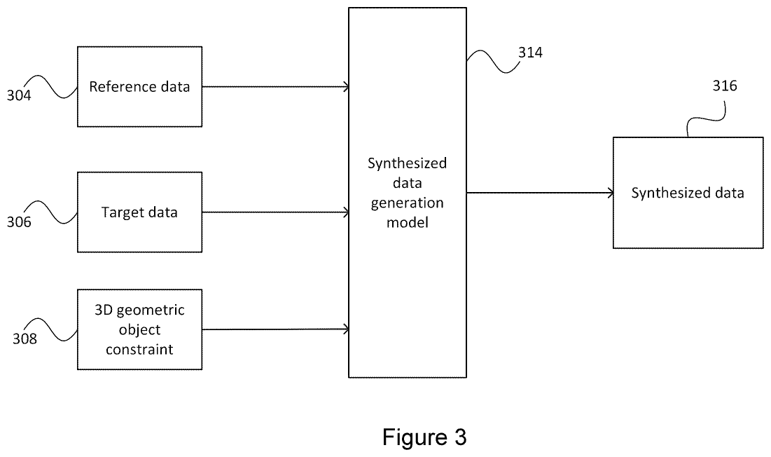

FIG. 3 shows a block diagram of an example trained synthesized data generation model 214 at inference time.

The synthesized data model 214 has been trained according to the training method described with reference to FIG. 2.

At inference time, the synthesized data generation model 314 receives latent space representations of reference data 304 and target data 306 as well as the 3D geometric object constraint 308.

The object in the reference data 304 may be subject to a 3D geometric object constraint 308 that changes the pose and/or orientation of the object in the synthesized data 316 when compared to the reference data 304. For example, if the object is a vehicle and the reference data 304 is an image of the vehicle, the desired orientation in the synthesized data 316 may differ when compared with the orientation of the vehicle in the reference data 304.

At inference time, the 3D geometric object constraint may be specified by a user. For example, with an image input, a graphical user interface may be provided, in which the image is displayed, and a projection of a configurable 3D bounding box is displayed in the image plane. The user is free to alter the 3D location, 3D pose and/or 3D dimensions of the 3D bounding box, and the projection of the 3D box in the image is updated in response to those changes. The user can ‘place’ the 3D box until the perspective view of the 3D box in the 2D image plane aligns with their intended object to be inserted. Once the 3D box has been finalized, a conditioning token at inference is derived from the final 3D box (e.g. its (x, y, d) coordinates in the image plane). As discussed, a more detailed 3D object model could be used in place of a 3D bounding box.

The synthesized data generation model 314 outputs the synthetic data 316. The synthesized data 316 is the object in the reference data 304 having been inserted into the target data 306 subject to the 3D geometric object constraint 308. The synthesized data generation model 314 may be a diffusion model.

FIG. 4 is an example of the inputs and outputs of a synthesized data generation model at inference time for one sensor modality. The synthesized data may be a driving scene for simulation-based testing of an AV stack.

In this example, a source scene 406 is captured by an image sensor, such as a camera. The source scene is of a drivable road area within a car park. The drivable road area has no objects in its path.

A reference picture 404 of an object is captured by an image sensor. The image may be the same image sensor used to capture the source scene or a different image sensor. The reference picture 404 is a front-on view of a vehicle driving on a road. The object in this example is the vehicle captured in the reference image 404.

An empty 3D bounding box 408 with a directional arrow can be seen overlaid on the road in the car park of the source scene 406. In this case, the arrow represents the orientation of the object to be inserted according to the bounding box. The 3D bounding box 408 may be added by a user to define the size, pose and/or orientation of the object to be inserted in the edited scene 416.

The 3D bounding box 408 can be considered the 3D geometric object constraint for the object in the reference picture 404 when inserting the object into the source scene 406. The dimensions and orientation of the object in the edited scene 416 are determined by the 3D bounding box in the source scene 408. Determining the object constraints using a 3D bounding box is described with reference to FIG. 2.

The synthesized data generation model receives the reference picture 404 and source scene 406, including the 3D bounding box 408, as input. The model generates the edited scene 416 by inserting the object in the reference picture 404 to the source scene 406 subject to the constraints defined by the 3D bounding box 408. The synthesized data generation model may be a diffusion model.

The method described above considers the case in which the inputs and outputs of the synthesized data generation model are associated with the same sensor modality. The method can be extended to apply to cases in which the input data received by the model is of a different sensor modality to the output of the model. For example, the model may receive reference data in the form of an image and the output synthesized data may be a LIDAR point cloud representative of the image, in a surrounding context.

FIG. 5 shows a block diagram of an example self-supervised training method for a multimodal synthesized data generation model. As noted, in the broadest sense, multi-modal in this context refers to the use of a reference input of one sensor modality to augment a target input of a different sensor modality. The following examples consider a reference image used to augment a target point cloud.

In the example of FIG. 5, two sensor modalities are considered, images and point clouds, the method however is not limited to only the combination of sensor modalities described. The dashed lines in the figure denote optional features that may be implemented in some embodiments.

In FIG. 5, a scene containing an object has been captured by two sensor modalities. In this example, a training image 502 and a training point cloud 522 of the same scene captured substantially simultaneously) containing the same object have been generated by a camera and a LIDAR sensor respectively. The image 502 captured by the camera is registered with the LIDAR sensor that has captured the point cloud 522 such that the pose of the camera is known in relation to the capture location of the point cloud 522. The location of the object in the data captured by both sensors is therefore associated. The image 502 could be a 2D image (e.g. RGB) or 3D image (e.g. RGBD). Even in the case of a 2D image, it is possible to annotate the 2D image with a 3D bounding box in (x, y, d) coordinates.

As discussed, the training point cloud 522 may be represented using an image-like view. The point cloud may be represented by an occupancy grid in the range with a depth channel to capture 3D information about the 3D point cloud.

An object is detected in an image 502 of the scene. The image 502 and the point cloud 522 are associated with known object properties 503. As a minimum, a location of the object is the image 502 and the point cloud 522 are known. Other properties of the object may also be known, such as its size and orientation (e.g. encapsulated in a 2D bounding box associated with the image 502 and a 3D bounding box or other 3D object model associated with the point cloud 522).

A reference image 504 is generated by isolating the object in the training image 502, and extracting a portion of the image 502 containing the reference object.

The point cloud 522 also undergoes a cropping process 525 to form a target point cloud 524. In contrast to the reference image 502, the target point cloud 523 omits the object, and is formed by removing a subset of points identified as belonging to the object. The subset of points may be the points contained within the projected points of a 3D bounding box surrounding the object. This is described in more detail below.

The reference image 504 and target point cloud 524 are input into a generative model 514, resulting in a generated output point cloud 516. Similarly to FIG. 2, a self-supervised reconstruction task is defined in training. A training loss 518 measures a reconstruction error between the original point cloud 522 and the generated output point cloud 516. Parameters of the generative model 514 are tuned so as to minimize the reconstruction error across a training set of similarly-constructed examples.

With the above training set-up, the generative model 514 learns to reconstruct the object in the point cloud from a reference image. This multi-modal knowledge generalizes at inference, enabling point clouds to be modified based on freely-chosen reference images.

Certain embodiments combine the architecture of FIG. 5 with that of FIG. 2 (e.g. as in the example of FIG. 7, described below). In this case, a 3D conditioning input is provided for the multi-modal inputs (e.g. image and lidar range views). Due to the difference in projection matrices between image and range views, the camera and range view generation for an object may have different bounding box conditioning tokens, however, both conditioning tokens correspond to the same 3D bounding box. The different 3D conditioning tokens simply reflect the fact that the same 3D bounding box has different coordinates in the image and range view coordinates.

In an extension of the techniques, the architecture may be extended to accommodate a second target input, in the form of an image. This is depicted by dotted line features in FIG. 5. In this case, in addition to generating the reference image 504 from the training image 502, a target image 506 (with the object removed) is also generated, and provided as a second target input. The architecture of the generative model 514 is additionally extended to generate an output image 526. The training loss 518 is additionally extended to measure the reconstruction error between the output image 526 and the training image 502. Thus, in training, its parameters are tuned so as to minimize a total reconstruction error (image and point cloud) across the training set.

As described with reference to FIG. 2, the generative model 514 and the training loss function 518 may operate on latent space representations of the synthesized point cloud 516 and the point cloud 522 to be used in calculation (e.g. in the form of feature vectors).

In the example of FIG. 5, the training image 502 and training point cloud 522 capture a common object (common to the image 502 and the point cloud 522) because they capture a common scene simultaneously. However, it is not necessary for training samples capturing a common object to be captured simultaneously. For example, a first training sample (providing a target) and a second sample (providing a reference) could be extracted from respective time sequences of samples of their respective modalities (e.g. one time sequence of images, and another time sequence of point clouds). In such cases, the first same and second sample could be taking from matching timestamps. Alternatively, the first sample could be taken from a different timestamp than the second sample, with the object common to both identified by tracking object(s) through time in the respective sequences (e.g. using object tracking applied to 2D or 3D object bounding boxes). Hence, the first and second samples could capture the same object (e.g. identified using temporal tracking) but at different times. This still enables training to be performed based on the same real-world object captured in different modalities, with the consequent benefits.

FIG. 6 shows an example block diagram of a multimodal synthesized data generation model at inference time. The multimodal synthesized data generation model is trained as described with reference to FIG. 5.

The multimodal synthesized data generation model 616 receives a reference image 604, a target point cloud 624 and 3D geometric object constraint 608 as input. The model 614 may optionally receive a target image 606 as input also. The reference image 604 contains an object to be inserted to the target point cloud 624. For example, the object could be a vehicle and the target point cloud 624 may be representative of a road. The model 614 outputs a synthesized point cloud 616. The synthesized point cloud 616 contains a point cloud representation of the object in the reference image 604 having been inserted into the target point cloud 624 subject to the conditioning constraints 608 on the size, pose and/orientation of the object. The model may optionally output a synthesized image 626 such that the object in the reference image 604 has been inserted into the target image 606 subject to the 3D geometric object constraint 608.

In this context, the 3D geometric object constraint 608 corresponds to the conditioning input 508 used to train the model. Both features constrain the size, pose and/orientation of the object in the synthesized data.

FIG. 7 shows an example block diagram of a training method for a multimodal diffusion model.

The multimodal diffusion model 714 may receive representations of multiple sensor modalities as input. Diffusion models initially generate a series of increasingly noisy outputs, starting from some initial input, in a Markov forward process. The forward process may add Gaussian noise to the initial inputs. The model 714 then employs a reverse process to denoise the noisy outputs from the previous step and is trained by minimizing a loss function.

In this context, the model 714 is being trained to learn a reverse process to generate synthesized data. In contrast, the Markov forward process is fixed such that it is not learnt during training. The reverse processes iteratively denoises the noisy outputs of the Markov process and the output at one timestep is only dependent on the adjacent timestep. For example, the denoise computation at xₜ₋₁ is only dependent on xₜ, in the reverse process.

An image sensor captures an image 702a of a scene. The image 702a contains an object. An object detector detects and annotates the object in the image 702a create an annotated image 702b.

The object is removed from the image 702a to create an image with removed object 706. A camera encoder 707a receives the image with removed object 706 and encodes the image 706 to output a set of image context features 709. The image context features 709 may be a latent space representation of the image with removed object 706.

$${X}_{t}^{cam}$$

710 adds noise to the image context features 709 of the image with object removed 706 at time t. The forward Markov process of the diffusion model 714 adds the noise at every timestep.

A modality specific adaptor 712a receives the combination of the image context features 709 and the noise 710. The adaptor 712a transforms the combination of the features 709 and the noise 710 into a form that can be consumed by the diffusion model 714.

The object in the bounding box of the annotated image 702b is removed to create a reference image 704. A CLIP encoder 707b receives the reference image 704 and transforms the image 704 into an abstracted description of the reference image 704 close to the text domain, e.g. a numerical feature vector. Using the CLIP encoding prevents the model 714 from overfitting and sticking too closely to the reference image 704 when generating synthesized data. This is achieved by masking details to force the model 714 to consider the masked image and the noisy image in 710.

A modality specific adaptor 712b receives the CLIP encoding of the reference image 704. The adaptor 712b transforms CLIP encoding into a representation that can be consumed by the diffusion model 714.

The diffusion model 714 receives the representation of the reference image 704 from the modality specific adaptor 712b at every time step of the process. This ensures that at every iteration of the reverse process, the model is working towards reconstructing the reference image in the context of the target data. In other words, it prevents the model from diverging from the object in the reference image.

A LIDAR encoder 707c receives a point cloud 722 of the same scene captured in the image 702. The LIDAR encoder receives the point cloud 722 with the object removed and encodes the point cloud with the object removed to output a set of range context features 729. The range context features 729 may be a latent space representation of the point cloud 722 with the object removed. As described with reference to FIG. 5, the sensors capturing the image 702 and point cloud 722 are registered.

$${X}_{t}^{range}$$

730 adds noise to the point cloud 722 with the object removed at time t. The forward Markov process of the diffusion model 714 generates the added noise at every timestep.

A modality specific adaptor 712c receives the combination of the range context features 729 and the noise 730. The adaptor 712a transforms the combination of the features 709 and the noise 729 into a form that can be consumed by the diffusion model 714.

The diffusion model 714 receives a label 740 and a 3D bounding box 742 describing the object in the image 702 and point cloud 722 at every timestep of the process. In training, the label 740 and 3D bounding box 742 describe the object captured in the image 702 and point cloud 722. This reinforces the constraints at each step of the reverse process so that the model 714 is continuously working towards generating synthesized data that contains the object as defined by the label 740 and bounding box 742. It prevents divergence from the desired output when learning the reverse process.

As indicated above, 3D bounding box 742 is projected onto the image 702 using a transformation matrix. Each of the 8 points of the bounding box 742 has 3 coordinates: x (from 0 to 1, 1 representing the image width), y (from 0 to 1, 1 representing the image height) and d (the distance from ego's origin to the point). The orientation of the bounding box 742 is determined by the order of the points. For the range view (an image-like representation of the lidar scan), a different projection matrix is used, but the format of the projected points is the same.

The points are embedded using an encoder (e.g., Fourier encoder) and passed through a fully-connected layer of the model. These bounding box features are concatenated with a label embedding 740 (e.g. feature vector for “car”, “pedestrian” etc.) and then passed through a multilayer perceptron (MLP). The result is then used as the conditioning input for the diffusion model 714.

As noted above, due to the difference in projection matrices, the camera and range view generation for an object have different bounding box conditioning, however, both conditioning tokens correspond to the same 3D bounding box 742.

Using the inputs described, the diffusion model 714 initially performs one iteration of the reverse denoising process.

Modality specific adaptors 732a, 732c receive outputs from the diffusion model 714.

After one iteration, the diffusion model 714 outputs an initial denoised representation of a synthesized image which is received and output by a modality specific adaptor 732a. The modality specific adaptor 732a encodes the output of the diffusion model in a representation that can be used in further processing.

A camera encoder 737a receives the original image including the object 702 and encodes the image 702 in latent space. Noise is added to the encoding at step t.

A loss function is calculated after each iteration between the encoded noisy output 711 from the diffusion model 714 and the encoding of the image with object with the added noise.

The output 711 from the diffusion model 714 at one timestep is used to add noise to the image context features 709 at the next timestep, before the diffusion model 714 receives the features as input for the next iteration.

After one iteration, the diffusion model 714 also outputs an initial denoised representation of a synthesized point cloud which is received and output by a modality specific adaptor 732c. As mentioned above, the modality specific adaptor 732a encodes the output of the diffusion model 714 in a representation that can be used in further processing.

A LIDAR encoder 737c receives the original point cloud 722 including the object and encodes the point cloud 722 in latent space. Noise is added to the encoding at step t.

A loss function is calculated after each iteration between the encoded noisy output 731 from the diffusion model 714 and the encoding of the point cloud 722 with added noise.

The two loss function calculations are performed with the original data for each modality. The original data having had the same level of noise added that should be expected in the output of the diffusion model 714. The loss function calculates the difference between the encoding of the synthesized data from the model 714 and the encoding of the original data with added noise.

The output from the diffusion model 714 at one timestep is used to add the noise to the range context features 729 before the diffusion model 714 receives it as input in the next iteration at the next timestep.

This process of calculating a loss function repeats for each time step until all the noise is removed in the outputs from the diffusion model 714. At this point, the diffusion model 714 should have reconstructed the original data from the inputs described above.

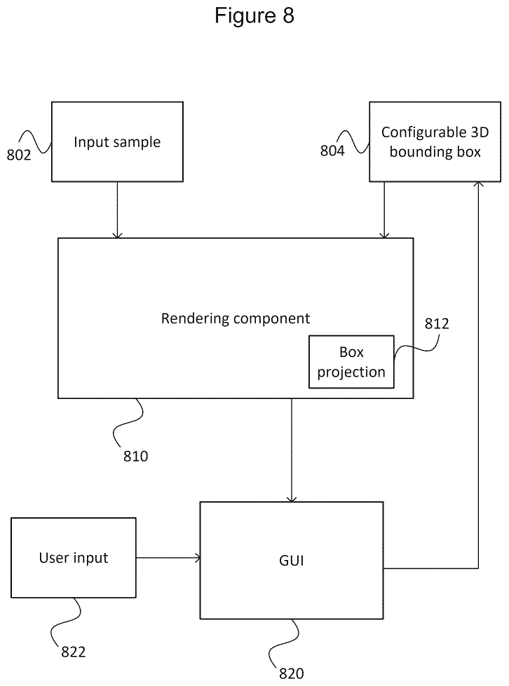

FIG. 8 shows a schematic function block diagram of a graphical tool for defining a 3D conditioning input at inference.

A rendering component 810 receives an input sample 802 and a configurable 3D bounding box 304 as input. The rendering component 810 outputs a visual representation the input sample 802 overlaid with a configurable bounding box 804.

The input sample 802 is a sample of spatial sensor data in which an object is to be inserted as described with reference to FIG. 3. For example, the input sample 802 may be an image or a range view, corresponding to a camera and a LIDAR sensor respectively.

The rendering component 810 may comprise a box projection component 812. The box projection component 812 transforms the 3D bounding box 804 into a 2D representation of box in the input sample.

The box projection component 812 may project the configurable 3D bounding box into the input sample 802 using a transformation matrix. In this case, the 3D bounding box 304 has eight corners which can be represented using eight 3D corner points. In one implementation, the 3D box is projected into the training sample 802 by projecting only the eight corner points into the image plane or range view plane. This is described in more detail in relation to FIG. 2.

The rendering component outputs the 2D representation of the configurable 3D bounding box 304 overlaid on the input sample 802 to a graphical user interface (GUI) 820.

The GUI 820 receives user input 822 such that a user may configure the 3D bounding box 804 by adjusting the 3D box 804 to visually alter the projection of the 3D box in the input sample 802. The user may alter the size and/or orientation of the bounding box 804 by moving the corner points of the box 804 as it appears on the GUI 820. This may be achieved by moving the points on a touchscreen or any suitable input means that allows the user to move the points on the GUI 820. Alternatively, the GUI 820 may display rotation arrows, movement arrows and/or a magnification button that the user can ‘click’ to move and/or resize the box 304 displayed on the GUI 820.

Each time the user configures the 3D box 804, the updated box 804 is received by the rendering component 810. The rendering component 810 then outputs the updated 3D bounding box 804 on the input sample 802 to be displayed to the user on the GUI 820. This process repeats until the final bounding box 304 is defined. The final bounding box 304 is considered to be the 3D conditioning input to be used to define the dimensions and orientation of an object to be inserted into the input sample 802 at inference.

As discussed, synthetic data has key uses in areas such as autonomous driving and robotics, for training, testing and/or validating perception components. For example, spatial sensor data captured by an AV sensor system may be augmented to create additional driving scenes to those captured by the sensor system. The synthesized data is sufficiently realistic to be consumed by perception component(s) of the AV stack and yield analytically useful outputs.

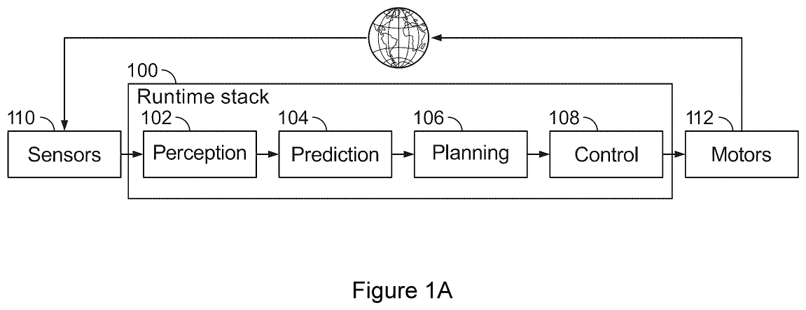

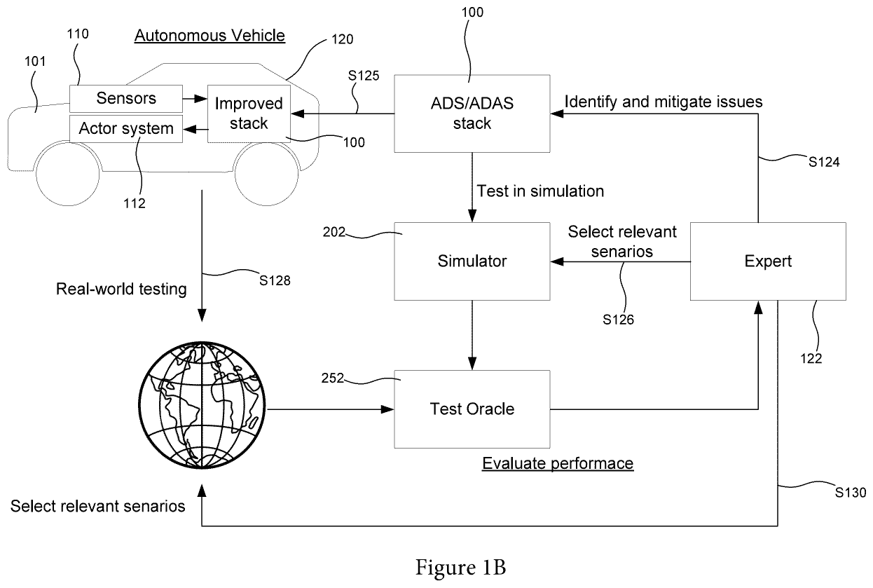

FIG. 1A shows, by way of context, a highly schematic block diagram of an AV runtime stack 100. The stack 100 is an example of a robotic system as discussed herein. The stack 100 may be fully or semi-autonomous. For example, the stack 100 may operate as an Autonomous Driving System (ADS) or Advanced Driver Assist System (ADAS).

The run time stack 100 is shown to comprise a perception system 102, a prediction system 104, a planning system (planner) 106 and a control system (controller) 108.

In a real-world context, the perception system 102 receives sensor outputs from an on-board sensor system 110 of the AV, and uses those sensor outputs to detect external agents and measure their physical state, such as their position, velocity, acceleration etc. The on-board sensor system 110 can take different forms but generally comprises a variety of sensors such as image capture devices (cameras/optical sensors), LIDAR and/or RADAR unit(s), satellite-positioning sensor(s) (GPS etc.), motion/inertial sensor(s) (accelerometers, gyroscopes etc.) etc. The onboard sensor system 110 thus provides rich sensor data from which it is possible to extract detailed information about the surrounding environment, and the state of the AV and any external actors (vehicles, pedestrians, cyclists etc.) within that environment. The sensor outputs typically comprise sensor data of multiple sensor modalities such as stereo images from one or more stereo optical sensors, LIDAR, RADAR etc. Sensor data of multiple sensor modalities may be combined using filters, fusion components etc.

The perception system 102 typically comprises multiple perception components which co-operate to interpret the sensor outputs and thereby provide perception outputs to the prediction system 104. Examples of such perception components include object detectors, such as bounding box detectors, pose detectors, segmentation components etc. Data collected from multiple sensors/sensor modalities may be combined in a way that respects their respective levels (e.g. using Bayesian or non-Bayesian processing or some other statistical process etc.).

The perception outputs from the perception system 102 are used by the prediction system 104 to predict future behaviour of external actors (agents), such as other vehicles in the vicinity of the AV.

Predictions computed by the prediction system 104 are provided to the planner 106, which uses the predictions to make autonomous driving decisions to be executed by the AV in a given driving scenario. The inputs received by the planner 106 would typically indicate a drivable area and would also capture predicted movements of any external agents (obstacles, from the AV's perspective) within the drivable area. The drivable area can be determined using perception outputs from the perception system 102 in combination with map information, such as an HD (high definition) map.

A core function of the planner 106 is the planning of trajectories for the AV (ego trajectories), taking into account predicted agent motion. This may be referred to as trajectory planning. A trajectory is planned in order to carry out a desired goal within a scenario. The goal could for example be to enter a roundabout and leave it at a desired exit; to overtake a vehicle in front; or to stay in a current lane at a target speed (lane following). The goal may, for example, be determined by an autonomous route planner 116, also referred to as a goal generator 116.

The controller 108 executes the decisions taken by the planner 106 by providing suitable control signals to an on-board actor system 112 of the AV. In particular, the planner 106 plans trajectories for the AV and the controller 108 generates control signals to implement the planned trajectories. Typically, the planner 106 will plan into the future, such that a planned trajectory may only be partially implemented at the control level before a new trajectory is planned by the planner 106. The actor system 112 includes “primary” vehicle systems, such as braking, acceleration and steering systems, as well as secondary systems (e.g. signalling, wipers, headlights etc.).

The example of FIG. 1A considers a relatively “modular” architecture, with separable perception, prediction, planning and control systems 102-108. The sub-stack themselves may also be modular, e.g. with separable planning modules within the planning system 106. For example, the planning system 106 may comprise multiple trajectory planning modules that can be applied in different physical contexts (e.g. simple lane driving vs. complex junctions or roundabouts). This is relevant to simulation testing for the reasons noted above, as it allows components (such as the planning system 106 or individual planning modules thereof) to be tested individually or in different combinations. For the avoidance of doubt, with modular stack architectures, the term stack can refer not only to the full stack but to any individual sub-system or module thereof.

The extent to which the various stack functions are integrated or separable can vary significantly between different stack implementations—in some stacks, certain aspects may be so tightly coupled as to be indistinguishable. For example, in other stacks, planning and control may be integrated (e.g. such stacks could plan in terms of control signals directly), whereas other stacks (such as that depicted in FIG. 1A) may be architected in a way that draws a clear distinction between the two (e.g. with planning in terms of trajectories, and with separate control optimizations to determine how best to execute a planned trajectory at the control signal level). Similarly, in some stacks, prediction and planning may be more tightly coupled. At the extreme, in so-called “end-to-end” driving, perception, prediction, planning and control may be essentially inseparable. Unless otherwise indicated, the perception, prediction planning and control terminology used herein does not imply any particular coupling or modularity of those aspects.

A “full” stack typically involves everything from processing and interpretation of low-level sensor data (perception), feeding into primary higher-level functions such as prediction and planning, as well as control logic to generate suitable control signals to implement planning-level decisions (e.g. to control braking, steering, acceleration etc.). For autonomous vehicles, level 3 stacks include some logic to implement transition demands and level 4 stacks additionally include some logic for implementing minimum risk maneuvers. The stack may also implement secondary control functions e.g. of signalling, headlights, windscreen wipers etc.

Whilst the following description refers to the stack 100 in the context of testing, testing may be applied to individual components/portions of the stack, such as the perception, prediction, planning or control stacks 104, 106, 108 (alone or in various combinations), or individual component(s) thereof. A stack (or component) can refer purely to software, i.e. one or more computer programs that can be executed on one or more general-purpose computer processors. However, such terminology can also encompass hardware. In simulation, software of the stack may be tested on a “generic” off-board computer system, before it is eventually uploaded to an on-board computer system of a physical vehicle. However, in “hardware-in-the-loop” testing, the testing may extend to underlying hardware of the vehicle itself. For example, the stack software may be run on the on-board computer system (or a replica thereof) that is coupled to the simulator for the purpose of testing. In this context, the stack under testing extends to the underlying computer hardware of the vehicle. As another example, certain functions of the stack 100 (e.g. perception functions) may be implemented in dedicated hardware. In a simulation context, hardware-in-the loop testing could involve feeding synthetic sensor data to dedicated hardware perception components.

FIG. 1B shows a highly schematic overview of a testing paradigm for autonomous vehicles. An ADS/ADAS stack 100, e.g. of the kind depicted in FIG. 1A, is subject to repeated testing and evaluation in simulation, by running multiple scenario instances in a simulator 202, and evaluating the performance of the stack 100 (and/or individual subs-stacks thereof) in a test oracle 252. The output of the test oracle 252 is informative to an expert 122 (team or individual), allowing them to identify issues in the stack 100 and modify the stack 100 to mitigate those issues (S124). The results also assist the expert 122 in selecting further scenarios for testing (S126), and the process continues, repeatedly modifying, testing and evaluating the performance of the stack 100 in simulation. The improved stack 100 is eventually incorporated (S125) in a real-world AV 101, equipped with a sensor system 110 and an actor system 112. The improved stack 100 typically includes program instructions (software) executed in one or more computer processors of an on-board computer system of the vehicle 101 (not shown). The software of the improved stack is uploaded to the AV 101 at step S125. Step S125 may also involve modifications to the underlying vehicle hardware. On board the AV 101, the improved stack 100 receives sensor data from the sensor system 110 and outputs control signals to the actor system 112. Real-world testing (S128) can be used in combination with simulation-based testing. For example, having reached an acceptable level of performance through the process of simulation testing and stack refinement, appropriate real-world scenarios may be selected (S130), and the performance of the AV 101 in those real scenarios may be captured and similarly evaluated in the test oracle 252.

In the present disclosure, the stack under test may receive synthesized data generated according to the methods described herein. The synthesized data may be used to test the perception system 102 of the stack. For example, the synthesized data may contain images of a pedestrian walking out into the path of the AV in simulation such that the test oracle 252 evaluates the performance of the perception system 102 in detecting the pedestrian.

References herein to components, functions, modules and the like, such as the components 102-108 of FIG. 1A, and the various components of FIGS. 2, 3, 5, 6, 7 and 8 denote functional components of a computer system, which may be implemented at the hardware level in various ways. A computer system comprises execution hardware which may be configured to execute the method/algorithmic steps disclosed herein. The term execution hardware encompasses any form/combination of hardware configured to execute the relevant method/algorithmic steps. The execution hardware may take the form of one or more processors, which may be programmable or non-programmable, or a combination of programmable and non-programmable hardware may be used. Examples of suitable programmable processors include general purpose processors based on an instruction set architecture, such as CPUs, GPUs/accelerator processors etc. Such general-purpose processors typically execute computer readable instructions held in memory coupled to or internal to the processor and carry out the relevant steps in accordance with those instructions. Other forms of programmable processors include field programmable gate arrays (FPGAs) having a circuit configuration programmable through circuit description code. Examples of non-programmable processors include application specific integrated circuits (ASICs). Code, instructions etc. may be stored as appropriate on transitory or non-transitory media (examples of the latter including solid state, magnetic and optical storage device(s) and the like).

Another aspect of the present disclosure provides a computer-implemented method of training a generative model to insert an object in spatial sensor data, the method comprising: receiving a training sample of spatial sensor data; receiving an indication of a 3D geometric property of an object captured in the training sample; removing from the training sample a portion of spatial sensor data corresponding to the object, resulting a cropped training sample; and training the generative model to reconstruct the training sample from the cropped training sample by: providing to the generative model: the cropped training sample as a target input, an indication of the object as a reference input, and the 3D geometric property of the object as a conditioning input, resulting in a generated output sample of spatial sensor data, and tuning parameters of the generative model to reduce a reconstruction error between the training sample and the generated output sample, resulting in a trained generative model configured to insert at inference, in a set of spatial sensor data received as a target input, an object indicated by a reference input with a desired 3D geometric property indicated by a conditioning input.

The above training mechanism enables a synthetic object to be more accurately inserted in 2D or 3D inputs at inference, based on a desired 3D geometric property or properties defined at inference. This provides a greater level of control, enabling more realistic object insertion at inference. This in turn supports use cases with robust data requirements, such as training, testing, or validating components for an autonomous vehicle stack.

The generative model may for example take the form of a neural network (e.g. transformer), whose parameters comprise weights.

In embodiments, the 3D geometric property of the object may indicate a 3D location, 3D pose and/or 3D extent of the object.

The 3D geometric property of the object may be a 3D bounding box or other 3D object model that indicates a 3D location, 3D pose and 3D extent of the object.

The conditioning input may be determined based on a projection of the 3D bounding box or other 3D object model into a view of the training sample.

The 3D geometric property may be determined automatically based on the spatial sensor data of the training sample or other spatial sensor data associated with the training sample.

The 3D geometric property may be determined based on a 3D bounding box or other 3D object model automatically detected based on the spatial sensor data or the other spatial sensor data.

The 3D geometric property may be determined by manual annotation.

The indication of the object may comprise the portion of spatial sensor data removed from the training sample.

The training sample may be an image.

The removed portion may be defined by a 2D bounding box or other 2D image region around the object in the image.

The spatial sensor data may be a 3D point cloud.

The generative model may be a diffusion model.

The reconstruction error may be measured between latent space representations of the training sample and the generated output sample.

A second conditioning input denoting a label embedding associated with the object may also be provided to the generative model.

The generative model may operate on a vector representation of the target input.

The generative model may be a diffusion model and employ a diffusion process to generate the output sample, the diffusion process may comprise: generating a series of increasingly noisy outputs of the target input and the reference input in a Markov forward process for a set of timesteps T; denoising the noisy outputs during a reverse process at each time step of the set of timesteps T, starting from T, to generate a denoised output; generating a noisy training sample by adding an expected noise to the training sample at every timestep; and minimizing a loss function between the noisy training sample and the denoised output at every timestep of the reverse process.

The generative model may receive a CLIP encoding of the reference input at every timestep of the diffusion process.

A further aspect of the present disclosure provides a computer-implemented method of using a trained a generative model to insert an object in spatial sensor data at inference, the method comprising: receiving an input sample of spatial sensor data; receiving an indication of a desired object; determining a 3D conditioning input denoting a desired 3D geometric object property; providing to the trained generative model the input sample, the indication of the desired object and the 3D conditioning input, resulting in an augmented output sample comprising the spatial sensor data augmented with object spatial sensor data reflecting the indication of the desired object exhibiting the desired 3D geometric object property.

In embodiments, the method may comprise rendering in a graphical user interface a view of the input sample and a projection of a 3D object model, the 3D object model configurable via user input, the 3D condition input derived from the 3D object model as configured via user input.

The input sample and the 3D conditioning input may be inputted to the trained generative model represented in said view of the training sample.

What is claimed is:

1. A computer-implemented method of training a generative model to insert an object in spatial sensor data, the method comprising:
receiving a first training sample of spatial sensor data of a first sensor modality, and a second training sample of spatial sensor data of a second sensor modality, the first training sample and the second training sample capturing a common object;
removing from the first training sample a first portion of sensor data corresponding to the object, resulting a cropped training sample;
extracting from the second training sample a second portion of spatial sensor data corresponding to the common object; and
training the generative model to reconstruct the first training sample from the cropped training sample by:
providing to the generative model:
the cropped training sample as a target input, and
the second portion of spatial sensor data as a reference input,
resulting in a generated output sample of spatial sensor data, and
tuning parameters of the generative model to reduce a reconstruction error between the first training sample and the generated output sample,
resulting in a trained generative model configured to insert at inference, in a first set of spatial sensor data of the first modality received as a target input, an object indicated in a second set of spatial sensor data of the second modality received as a reference input.

2. The method of claim 1, wherein the first training sample is a point cloud and the second training sample is an image.

3. The method of claim 2, wherein the point cloud is a lidar point cloud or other 3D point cloud.

4. The method of claim 1, wherein the method further comprises:
removing from the second training sample the second portion of sensor data, resulting a second cropped training sample;
wherein the generative model is additionally trained to reconstruct the second training sample from the second cropped training sample by additionally providing to the generative model the second cropped training sample as a second target input, resulting in a second generated output sample of spatial sensor data, the parameters of the generative model to additionally reduce a reconstruction error between the second training sample and the second generated output sample.

5. The method of claim 1, wherein a conditioning input encoding a 3D geometric property of the common object is provided to the generative model for the cropped training sample.

6. The method of claim 4, wherein a conditioning input encoding a 3D geometric property of the common object is provided to the generative model for the cropped training sample; and
wherein a second conditioning input encoding the 3D geometric property is additionally provided for the second cropped training sample, the conditioning input and second conditioning input representing the 3D geometric property in respective coordinate systems of the first training sample and the second training sample.

7. The method of claim 6, wherein the conditioning input and second conditioning input are determined via projection of a 3D object model into the respective coordinate systems.

8. The method of claim 1, wherein the first sensor modality is a lidar modality and the second sensor modality is a camera modality.

9. The method of claim 5, wherein the 3D geometric property of the object indicates a 3D location, 3D pose and/or 3D extent of the object.

10. The method of claim 6, wherein the 3D geometric property of the object is a 3D bounding box or other 3D object model indicating a 3D location, pose and extent of the object.

11. The method of claim 10, wherein the conditioning input is determined based on a projection of a 3D bounding box or other 3D object model into a view of the training sample.

12. The method of claim 1, wherein the common object is detected and annotated automatically based on the spatial sensor data of the training sample or other spatial sensor data associated with the training sample.

13. The method of claim 1, wherein the reconstruction error is measured between latent space representations of the training sample and the generated output sample.

14. The method of claim 1, wherein the generative model operates on vector representations of the target input and the reference input.

15. The method of claim 1, wherein the generative model is a diffusion model and employs a diffusion process to generate the output sample, the diffusion process comprising:
generating a series of increasingly noisy outputs of the target input and the reference input in a Markov forward process for a set of timesteps T;
denoising the noisy outputs during a reverse process at each time step of the set of timesteps T, starting from T, to generate a denoised output;
generating a noisy training sample by adding an expected noise to the training sample at every timestep; and
minimizing a loss function between the noisy training sample and the denoised output at every timestep of the reverse process.

16. A computer-implemented method of using a trained a generative model to insert a desired object in spatial sensor data at inference, the method comprising:
receiving an input sample of first spatial sensor data of a first sensor modality;
receiving a reference input of second spatial sensor data of a second sensor modality, the second spatial sensor data capturing a desired object;
providing to the trained generative model the input sample of first spatial sensor data and the reference input, resulting in an augmented output sample of the first spatial sensor data comprising the input sample of the first spatial sensor data augmented with the second spatial sensor data reflecting the desired object.

17. The computer-implemented method of claim 16, wherein, the method further comprises:
receiving an input sample of second spatial sensor data;
providing to the trained generative model the input sample of second spatial sensor data, resulting in an augmented output sample of the second spatial sensor data comprising the input sample of the second spatial sensor data augmented with the second spatial sensor data reflecting indication of the desired object.

18. The computer-implemented method of claim 16, wherein a conditioning input encoding a 3D geometric property of the desired object is provided to the generative model.

19. A computer system for training a generative model to insert an object in spatial sensor data, the computer system comprising:
at least one memory storing computer-readable instructions; and
at least one processor coupled to the at least one memory and configured to execute the computer-readable instructions, which upon execution cause the at least one processor to:
receive a first training sample of spatial sensor data of a first sensor modality, and a second training sample of spatial sensor data of a second sensor modality, the first training sample and the second training sample capturing a common object;
remove from the first training sample a first portion of sensor data corresponding to the object, resulting a cropped training sample;
extract from the second training sample a second portion of spatial sensor data corresponding to the common object; and
train the generative model to reconstruct the first training sample from the cropped training sample by:
providing to the generative model:
the cropped training sample as a target input, and
the second portion of spatial sensor data as a reference input,
resulting in a generated output sample of spatial sensor data, and
tuning parameters of the generative model to reduce a reconstruction error between the first training sample and the generated output sample,
resulting in a trained generative model configured to insert at inference, in a first set of spatial sensor data of the first modality received as a target input, an object indicated in a second set of spatial sensor data of the second modality received as a reference input.

20. A non-transitory computer readable medium embodying computer program instructions, the computer program instructions configured so as, when executed on one or more hardware processors, to implement operations comprising:
receiving a first training sample of spatial sensor data of a first sensor modality, and a second training sample of spatial sensor data of a second sensor modality, the first training sample and the second training sample capturing a common object;
removing from the first training sample a first portion of sensor data corresponding to the object, resulting a cropped training sample;
extracting from the second training sample a second portion of spatial sensor data corresponding to the common object; and
training a generative model to reconstruct the first training sample from the cropped training sample by:
providing to the generative model:
the cropped training sample as a target input, and
the second portion of spatial sensor data as a reference input,
resulting in a generated output sample of spatial sensor data, and
tuning parameters of the generative model to reduce a reconstruction error between the first training sample and the generated output sample,
resulting in a trained generative model configured to insert at inference, in a first set of spatial sensor data of the first modality received as a target input, an object indicated in a second set of spatial sensor data of the second modality received as a reference input.
